(19) United States
(12) Patent Application Publication
(10) Pub. No.: US 2015/0371590 A1
(43) Pub. Date: Dec. 24, 2015

(54) PIXEL AND ORGANIC LIGHT EMITTING DISPLAY DEVICE USING THE SAME

(71) Applicant: SAMSUNG DISPLAY CO., LTD., Yongin-City (KR)

(72) Inventors: Jin-Tae JEONG, Yongin-City (KR); Hwan-Soo JANG, Yongin-City (KR)

(21) Appl. No.: 14/679,389

(22) Filed: Apr. 6, 2015

(30) Foreign Application Priority Data
Jun. 23, 2014 (KR) 10-2014-0076714

(51) Int. Cl. G09G 3/32; G09G 5/18

(52) U.S. Cl. CPC G09G 3/3291; G09G 5/18

(57) ABSTRACT

A pixel includes an organic light emitting diode and a pixel circuit. The pixel circuit includes a first transistor to control current from a first power source to the OLED based on a voltage applied to a first node, and a second transistor connected between the first node and a data line, the second transistor to turn on based on a scan signal applied to a scan line. The pixel circuit also includes a controller to supply a voltage from a power line to at least one of the first node or an anode electrode of the OLED.

### CROSS-REFERENCE TO RELATED APPLICATION

Korean Patent Application No. 10-2014-0076714, filed on Jun. 23, 2014, and entitled, “Pixel and Organic Light Emitting Display Device Using the Same,” is incorporated by reference herein in its entirety.

### BACKGROUND

1. Field

One or more embodiments described herein relate to a pixel and an organic light emitting display device using the pixel.

2. Description of the Related Art

Display devices serve as connection mediums between users and information sources. These devices include various flat panel displays including but not limited to liquid crystal displays, organic light emitting displays, and plasma displays. Organic light emitting displays generate images using organic light emitting diodes (OLEDs). These diodes generates light based on a recombination of electrons and holes in an active layer. Displays of this type have high response speeds and low power consumption.

### SUMMARY

In accordance with one embodiment, a pixel includes an organic light emitting diode (OLED) and a pixel circuit, which includes a first transistor to control current from a first power source to the OLED based on a voltage applied to a first node; and a second transistor connected between the first node and a data line, the second transistor to turn on based on a scan signal applied to a scan line; and a controller to supply a voltage from a power line to at least one of the first node or an anode electrode of the OLED.

The controller may include a third transistor and a fourth transistor connected in series between the anode electrode of the OLED and the power line, and a common node of the third transistor and the fourth transistor is connected to the first node. The controller may include a third transistor connected between the anode electrode of the OLED and the power line; and a fourth transistor connected between the first node and the power line. The controller may includes a third transistor connected between the anode electrode of the OLED and a initial power source; and a fourth transistor connected between the first node and the power line.

The pixel circuit may include a first capacitor and a second capacitor connected in series between the first node and the first power source; a fifth transistor connected between a first electrode of the first transistor and the first power source; and a sixth transistor connected between a second electrode of the first transistor and the anode electrode of the OLED, wherein a common node of the first capacitor and the second capacitor is connected to the first electrode of the first transistor.

In accordance with another embodiment, an organic light emitting display device includes pixels in a region including scan lines, data lines, and power lines, the pixels to be supplied with a predetermined voltage from the power lines; i blocks divided to include two or more scan lines, where i≧2; a control driver to provide a first control signal to i first control lines, a second control signal to i second control lines, and a third control signal to i third control lines; a scan driver to provide a scan signal to the scan lines; and a data driver including a plurality of output lines, the data driver to provide a data signal to the data lines connected to the output lines, wherein the power lines are to be supplied with an initial voltage from the output lines or an initial power source.

The device may include a plurality of switching circuits connected to respective ones of the output lines, each of the switching circuits connected to one of the power lines and one of the data lines. One of the switching circuits connected to a k-th output line may include a first switch connected between the k-th output line and a k-th power line, the first switch to turn on based on a first switching control signal; and a second switch connected between the k-th output line and a k-th data line, the second switch to turn on based on a second switching control signal.

The first switching control signal may be provided before the scan signal is provided to the scan lines in a corresponding one of the blocks, and the second switching control signal may be provided during a period when the scan signal is provided to the scan lines in the corresponding one of the blocks.

The data driver may supply a first voltage of the initial power source to the k-th output line during a period when the first switching control signal is provided, the first voltage to block supply of data to the output line, and may provide the data signal to the k-th output line during a period when the second switching control signal is provided.

The device may include a plurality of switching circuits connected to respective ones of the output lines, multiple ones of the power lines, and multiple ones of the data lines. Each switching circuit may include a first switch connected between a corresponding one of the output lines and the multiple ones of the power lines, the first switch to turn on based on a first switching control signal; and second switches connected between the corresponding one of the output lines and the multiple ones of the data lines, the second switches to turn on in response to a plurality of se

[symbol]

The first switching control signal may be provided before the scan signal is provided to the scan lines in a corresponding one of the blocks, and the second switching control signals may be sequentially provided during a first horizontal period when the scan signal is provided to the scan lines in the corresponding one of the blocks.

The data driver may supply a voltage of the initial power source, at which OLEDs in the pixels are turned off, to the output lines during a period when the first switching control signal is provided, and sequentially provide data signals to the output lines during a period when the second switching control signals are provided.

The control driver may provide the second control signal to a j-th second control line after providing the first control signal to a j-th first control line, and is to stop providing the second control signal after the first control signal is stopped being provided, and may provide the third control signal to a j-th third control line before providing the first control signal to the j-th first control line, and is to stop providing the third control signal before the scan signal is provided to scan lines in a j-th block.

The scan driver may sequentially provide the scan signal to the scan lines in the j-th block when the first control signal provided to the j-th first control line overlaps the second control signal provided to the j-th second control line.

The first control signal and the second control signal may be set to a voltage at which pixel transistors are turned off, and the third control signal and the scan signal may be set to a voltage at which the pixel transistors are turned on.

The scan driver may simultaneously provide the scan signal to the scan lines in the j-th block, and may sequentially stop providing the scan signal when the first control signal provided to the j-th first control line overlaps the second control signal provided to the j-th second control line.

Each of the pixels in the j-th block may include an OLED and a pixel circuit, which includes a first transistor to control a current supplied from a first power source to the OLED depending on a voltage applied to the first node; a second transistor connected between the first node and a data line, the second transistor to turn on when a scan signal is provided to a scan line; a first capacitor and a second capacitor connected in series between a first electrode of the first transistor and the first power source, a common node of the first and second capacitors connected to the first electrode of the first transistor; a fifth transistor connected between the first electrode of the first transistor and the first power source, the fifth transistor to turn off when the first control signal is provided to a j-th first control line; a sixth transistor connected between the second electrode of the first transistor and an anode electrode of the OLED, the sixth transistor to turn off when the second control signal is provided to a j-th second control line; and a controller to connect a power line to at least one of the first node or the anode electrode of the OLED when a third control signal is provided to a j-th third control line.

The controller may include a third transistor and a fourth transistor connected in series between the anode electrode of the OLED and the power line, wherein the third and fourth transistors are to turn on when the third control signal is provided to the j-th third control line, and wherein a common node of the third and fourth transistors are connected to the first node.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light emitting display;

FIG. 2 illustrates an embodiment of a pixel;

FIG. 3 illustrates an embodiment of a switching unit;

FIG. 4 illustrates an embodiment of a method for driving a display;

FIG. 5 illustrates another embodiment of a method for driving a display;

FIG. 6 illustrates another embodiment of a pixel;

FIG. 7 illustrates another embodiment of a pixel;

FIG. 8 illustrates another embodiment of an organic light emitting display;

FIG. 9 illustrates another embodiment of a switching unit;

FIG. 10 illustrates an example of how the switching unit in FIG. 8 operates; and

FIG. 11 illustrates another embodiment of an organic light emitting display.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

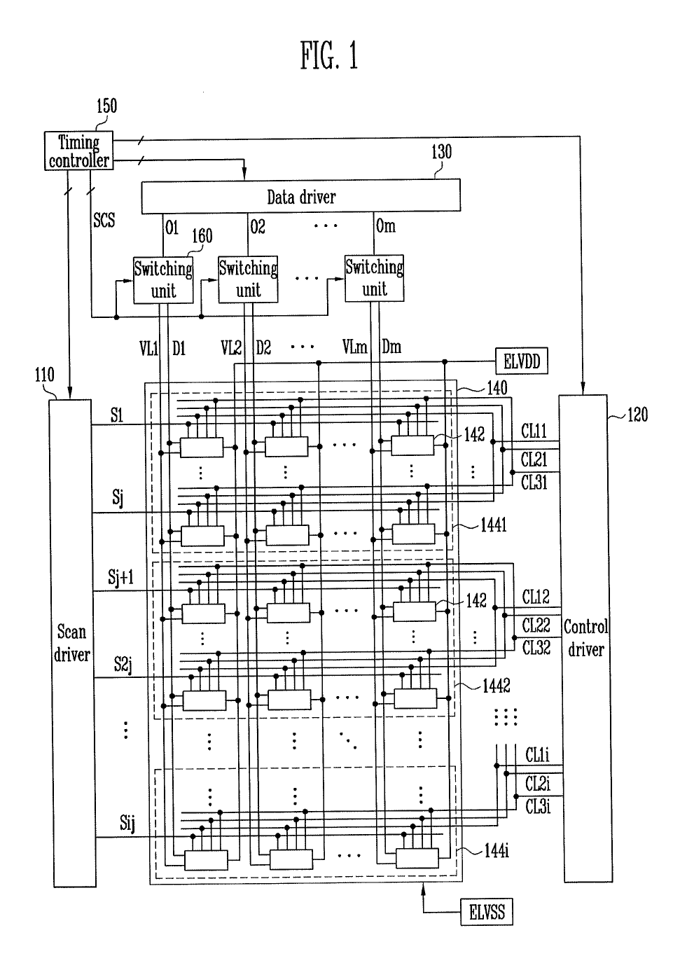

FIG. 1 illustrates an embodiment of an organic light emitting display device which includes a pixel unit 140 having pixels 142 in a region defined by scan lines S1 to Sij, data lines D1 to Dm, and power lines VL1 to VLm. The display device also includes a scan driver 110 to drive i blocks 1441 to 44i that are divided to include two or more scan lines and to drive the scan lines S1 to Sij.

The display also includes a control driver 120, a data driver, a plurality of switching units 160, and a timing controller 150. The control driver 120 drives first control lines CL11 to CL1i, second control lines CL21 to CL2i, and third control lines CL31 to CL3i which are formed on every block. The data driver 130 supplies a voltage of an initial power source and a data signal to output lines O1 to Om. The switching units 160 are connected to respective ones of the output lines O1 to Om. The timing controller 150 controls the drivers 110, 120 and 130 and provides a switching control signal SCS to the switching units 160.

The pixel unit 140 is divided into i blocks 1441 to 144i. Each of the blocks 1441 to 144i includes a plurality of pixels 142. The pixels 142 in a same block simultaneously compensate for the threshold voltages of the driving transistors in the pixels 142. When the threshold voltages of the driving transistors are compensated for in blocks 1441 to 144i, it is possible to assign a sufficient threshold-voltage compensation time to allow for stable compensation of the threshold voltages of the driving transistors.

For each block (e.g., blocks 1441 to 144i), there is provided one first control line (CL11 to CL1i, respectively), one second control line (any one of CL21 to CL2i, respectively), and one third control line (any one of CL31 to CL3i, respectively). To this end, i first control lines CL11 to CL1i, i second control line CL21 to CL2i and i third control lines CL31 to CL3i are formed for the pixel units 140. Further, a k-th first control line CL1k, a k-th second control line CL2k and a k-th third control line CL3k, which are formed on a k-th block, are commonly connected to the pixels 142 at the k-th block.

The control driver 120 sequentially provides a first control signal to the first control lines CL11 to CL1i, sequentially provides a second control signal to the second control lines CL21 to CL2i, and sequentially provides a third control signal to the third control lines CL31 to CL3i. The second control signal to the k-th second control line CL2k starts to be provided after the first control signal has been provided to the k-th first control line CL1k, and is stopped after the provision of the first control signal has been stopped. Further, the control driver 120 provides the third control signal to the k-th third control line CL3k before the first control signal is provided to the k-th first control line CL1k, and stops providing the third control signal before the scan signal is provided.

The first and second control signals are set to a voltage (e.g., high voltage) at which a transistor in the pixels 142 is turned off. The third control signal is set to a voltage (e.g., low voltage) at which the transistor in the pixels 142 is turned on.

The scan driver 110 provides a scan signal to the scan lines S1 to Sij, for example, on a block basis. For example, the scan driver 110 may sequentially provide the scan signal to the scan lines at the k-th block during a period when the first control signal of the k-th first control line CL1k overlaps the second control signal of the k-th second control line CL2k.

Further, the scan driver 110 may sequentially stop providing the scan signal after the scan signal has been simultaneously provided to the scan lines at the k-th block, during a period when the first control signal of the k-th first control line CL1k overlaps the second control signal of the k-th second control line CL2k. The scan signal is set to a voltage at which the transistor included in the pixels 142 is turned on.

Although FIG. 1 illustrates the scan driver 110 and the control driver 120 as separate drivers, the scan driver 110 and the control driver 120 may be implemented as one driver in an alternative embodiment.

The data driver 130 provides the initial power and the data signal to the output lines O1 to Om. For example, the data driver 130 provides the voltage of the initial power source to the output lines O1 to Om during a period when the third control signal is provided, and provides the data signal to the output lines O1 to Om during a period when the scan signal is provided. When the initial power is supplied to an anode electrode of an OLED, it is set to the voltage at which the OLED is turned off. To this end, the initial power may be set to a voltage which is lower than the sum of the threshold voltage of the OLED and a second power source ELVSS, e.g., a voltage which is the same as the second power source ELVSS.

The switching units 160 are connected to respective power lines (VL1 to VLm) and respective data lines (D1 to Dm). Each switching unit 160 selectively connects a one of the output lines (O1 to Om) to a corresponding one of the power lines (VL1 to VLm) or the data lines (D1 to Dm) in response to the switching control signals SCS from the timing controller 150. For example, the switching unit 160 connects the output lines O1 to Om to the power lines VL1 to VLm during a period when the third control signal is provided, and connects the output lines O1 to Om to the data lines D1 to Dm during a period when the scan signal is provided.

The pixels 142 are located at regions defined by the scan lines S1 to Sij, the data lines D1 to Dm, and the power lines VL1 to VLm. The pixels 142 generate a predetermined luminance of light by controlling a current that flows from the first power source ELVDD through the OLED to the second power source ELVSS in response to the data signal.

The timing controller 150 controls the scan driver 110, the control driver 120 and the data driver 130. The timing controller 150 also generates the switching control signals SCS for input into the switching units 160.

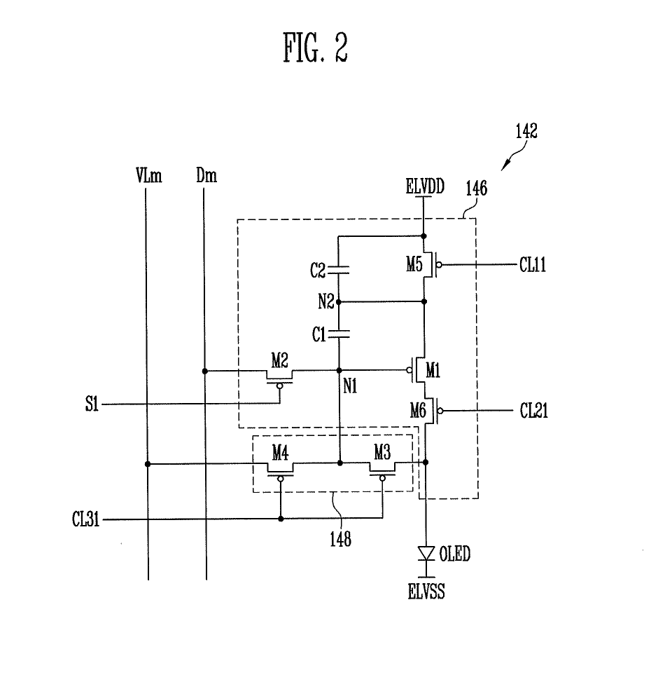

FIG. 2 illustrates a first embodiment of a pixel 142, which, for convenience of description, is connected to the m-th data line Dm and the first scan line S1. Referring to FIG. 2, the pixel 142 includes an OLED, a pixel circuit 146 to control current to the OLED, and a controller 148 to supply an initial voltage from the power line VLm to a first node N1 and the anode electrode of the OLED.

The OLED has an anode electrode connected to the pixel circuit 146 and a cathode electrode connected to the second power source ELVSS. The OLED emits light of a predetermined luminance based on a current supplied from the pixel circuit 146. The voltage of the second power source ELVSS may be set to be lower than that of the first power source ELVDD, in order to allow current to flow in the OLED.

The pixel circuit 146 controls the current to the OLED based on the data signal. In this embodiment, the pixel circuit 146 includes a first transistor M1, a second transistor M2, a fifth transistor M5, a sixth transistor M6, a first capacitor C1, and a second capacitor C2.

The first transistor (driving transistor) M1 has a first electrode connected, via the fifth transistor M5, to the first power source ELVDD, and a second electrode connected, via the sixth transistor M6, to the anode electrode of the OLED. A gate electrode of the first transistor M1 is connected to the first node N1. The first transistor M1 controls the current that flows from the first power source ELVDD through the OLED to the second power source ELVSS in response to the voltage applied to the first node N1.

The second transistor M2 has a first electrode connected to the data line Dm, and a second electrode connected to the first node N1. The gate electrode of the second transistor M2 is connected to the scan line S1. When the scan signal is provided to the scan line S1, the second transistor M2 is turned on. As a result, the data line Dm is electrically connected to the first node N1.

The fifth transistor M5 has a first electrode connected to the first power source ELVDD, and a second electrode connected to the first electrode of the first transistor M1. The gate electrode of the fifth transistor M5 is connected to the first control line CL11. The fifth transistor M5 is turned off when the first control signal is provided to the first control line CL11, and is turned on in other cases.

The sixth transistor M6 has a first electrode connected to the second electrode of the first transistor M1, and a second electrode connected to the anode electrode of the OLED. The gate electrode of the sixth transistor M6 is connected to the second control line CL21. The sixth transistor M6 is turned off when the second control signal is supplied to the second control line CL21, and is turned on in other cases.

The first capacitor C1 and the second capacitor C2 are connected in series between the first node N1 and the first power source ELVDD. The second node N2 is a common node of the first and second capacitors C1 and C2, and is electrically connected to the first electrode of the first transistor M1. The first and second capacitors C1 and C2 store the threshold voltage of the first transistor M1 and the voltage corresponding to the data signal.

The controller 148 electrically connects the power line VLm to the first node N1 and the anode electrode of the OLED in response to the third control signal provided to the third control line CL31. To this end, the controller 148 is provided with a third transistor M3 and a fourth transistor M4.

The third transistor M3 and the fourth transistor M4 are connected in series between the anode electrode of the OLED and the power line VLm. Further, the common node of the third and fourth transistors M3 and M4 is electrically connected to the first node N1. The third and fourth transistors M3 and M4 are turned on when the third control signal is provided to the third control line CL31. As a result, the power line VLm is electrically connected to the first node N1 and the anode electrode of the OLED.

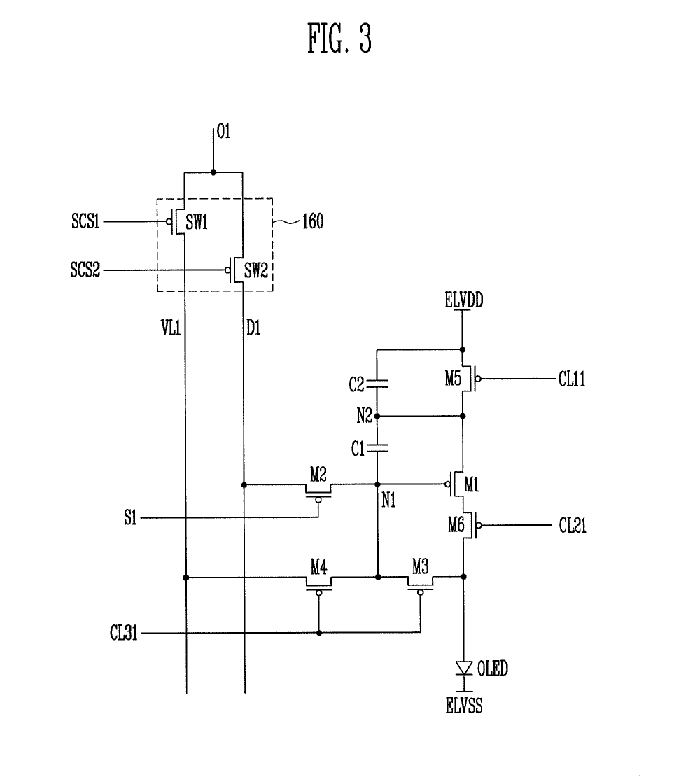

FIG. 3 illustrates an embodiment of a switching unit, which, for example, may correspond to the switching units 160 connected to the first output line O1. Referring to FIG. 3, the switching unit 160 connects the output line O1 to the power line VL1 or the data line D1 in response to the switching control signals SCS1 and SCS2. To this end, the switching unit 160 includes a first switch SW1 and a second switch SW2.

The first switch SW1 is between the output line O1 and the power line VL1, and is turned on by the first switching control signal SCS1. The first switching control signal SCS1 is provided during a period when the third control signal is provided. Thus, the output line O1 is electrically connected to the power line VL1 during the period when the third control signal is provided.

The second switch SW2 is between the output line O1 and the data line D1, and is turned on by the second switching control signal SCS2. The second switching control signal SCS2 is provided during a period when the scan signal is provided. Thus, the output line O1 is electrically connected to the data line D1 during the period when the scan signal is provided.

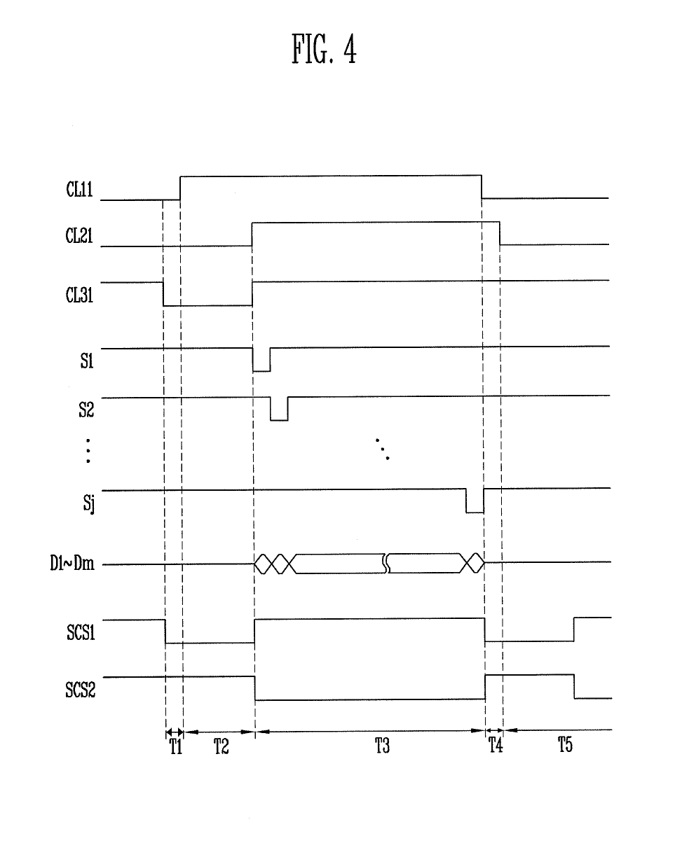

FIG. 4 illustrates a first embodiment of a method for driving a display panel, which, for example, may be the display panel in FIG. 1. For convenience of description, FIG. 4 shows a driving waveform provided to the first block 1441.

Referring to FIG. 4, the first control signal is provided to the first control line CL11 during a second period T2 and a third period T3. The second control signal is provided to the second control line CL21 during a third period T3 and a fourth period T4. Further, the third control signal is provided to the third control line CL31 during the first period T1 and the second period T2. Further, the first switching control signal SCS1 is provided during the first period T1 and the second period T2, while the second switching control signal SCS2 is provided during the third period T3.

In the first period T1, the third and fourth transistors M3 and M4 of each of the pixels 142 at the first block 1441 are turned on in response to the third control signal. Simultaneously, the first switch SW1 is turned on in response to the first switching control signal SCS1.

When the first switch SW1 is turned on, the output lines O1 to Om are connected to the power lines VL1 to VLm. Then, the voltage of the initial power source is supplied from the data driver 130 to the power lines VL1 to VLm. When the third and fourth transistors M3 and M4 are turned on, the first node N1 of each of the pixels 142 in the first block 1441 and the anode electrode of the OLED are electrically connected to a corresponding one of the power lines (one of VL1 to VLm). Then, the voltage of the initial power source is supplied to the anode electrode of the OLED and the first node N1. When the voltage of the initial power source is supplied to the anode electrode of the OLED, an organic capacitor parasitically formed on the OLED is discharged and the OLED is initialized.

When the voltage of the initial power source is supplied to the first node N1, the first transistor M1 is turned on. When the first transistor M1 turns on, a predetermined current flows from the first power source ELVDD through the fifth transistor M5, the first transistor M1, the sixth transistor M6, the third transistor M3, and the fourth transistor M4 to a corresponding one of the power lines (one of VL1 to VLm). For example, during the first period T1, the first transistor M1 may be set to an on-bias state, so that it is possible to display an image with uniform luminance.

For instance, the first transistor M1 in each of the pixels 142 sets voltage characteristics non-uniformly according to the gray scale of a previous period. In one embodiment, during the first period T1, the first transistor M1 of each of the pixels 142 in the first block 1441 is initialized to the on-bias state, so that the voltage characteristics may be set uniformly. Further, because the current flowing through the first transistor M1 is supplied to a corresponding one of the power lines (one of VL1 to VLm) during the first period T1, the OLED maintains a non-luminous state.

In the second period T2, the first control signal is provided to the first control line CL11. When the first control signal is provided to the first control line CL11, the fifth transistor M5 of each of the pixels 142 in the first block 1441 is turned off. When the fifth transistor M5 is turned off, the first power source ELVDD is electrically interrupted from the second node N2. In this case, the first node N1 maintains the voltage of the initial power source.

Thus, during the second period T2, a predetermined current flows from the second node N2 of each of the pixels 142 in the first block 1441 through the first transistor M1, the sixth transistor M6, the third transistor M3, and the fourth transistor M4 to a corresponding one of the power lines (one of VL1 to VLm). Then, the voltage of the second node N2 is decreased from the voltage of the first power source ELVDD to the voltage that is the sum of the voltage of the initial power source and an absolute threshold voltage of the first transistor M1. When the voltage of the second node N2 is set to the voltage that is the sum of the voltage of the initial power source and the absolute threshold voltage of the first transistor M1, the first transistor M1 is turned off. Then, the first capacitor C1 is charged with the voltage corresponding to the threshold voltage of the first transistor M1.

Moreover, in the second period T2, the threshold voltages of the first transistors M1 in the first block 1441 are simultaneously compensated for. Therefore, it is possible to allocate a sufficient time to the second period T2 to allow the threshold voltage to be stably compensated for.

In the third period T3, providing of the third control signal to the third control line CL31 is stopped, so that the third and fourth transistors M3 and M4 of each of the pixels 142 in the first block 1441 are turned off. Further, the second control signal is provided to the second control line CL21, so that the sixth transistor M6 of each of the pixels 142 in the first block 1441 is turned off. When the sixth transistor M6 is turned off, the OLED and the first transistor M1 of each of the pixels 142 at the first block 1441 are electrically interrupted from each other.

Further, in the third period T3, the scan signal is sequentially provided to the scan lines S1 to Sj, and the second switch SW2 is turned on in response to the second switching control signal SCS2. When the second switch SW2 is turned on, the output lines O1 to Om are connected to the data lines D1 to Dm. Then, in order to be synchronized with the scan signal during the third period T3, the data signal is provided from the data driver 130 to the data lines D1 to Dm.

When the scan signal is provided to the first scan line S1, the second transistor M2 of each of the pixels 142 positioned in a first horizontal line is turned on. When the second transistor M2 is turned on, the data signal is provided from the data line (one of D1 to Dm) to the first node N1. When the data signal is provided to the first node N1, the voltage of the first node N1 is changed from the voltage of the initial power source to the voltage of the data signal. In this case, the voltage of the second node N2 is changed depending on the voltage variance of the first node N1.

For example, the voltage of the second node N2 is changed to a predetermined voltage depending on the capacitance ratio of the first capacitor C1 and the second capacitor C2. Then, the first capacitor C1 is charged with the threshold voltage of the first transistor M1 and the voltage corresponding to the data signal. Similarly, during the third period T3, the scan signal is sequentially provided to the second scan line S2 to the j-th scan line Sj, and the first capacitor C1 of each pixel 142 is charged with the voltage corresponding to the data signal.

In the fourth period T4, providing the first control signal to the first control line CL11 is stopped. When providing of the first control signal is stopped, the fifth transistor M5 is turned on. When the fifth transistor M5 is turned on, the voltage of the first power source ELVDD is provided to the second node N2 of each pixel of the first block 1441. Because the first node N1 is set to a floating state, the first capacitor C1 stably maintains the voltage that has been charged in the previous period.

In the fifth period T5, providing the second control signal to the second control line CL21 is stopped, so that the sixth transistor M6 of each pixel 142 in the first block 1441 is turned on. When the sixth transistor M6 is turned on, the first transistor M1 of each pixel 142 in the first block 1441 is electrically connected to the anode electrode of the OLED. Thus, the first transistor M1 controls the current supplied to the OLED depending on the voltage stored in the first capacitor C1. That is, in the fifth period T5, the pixels 142 in the first block 1441 simultaneously emit light in response to the data signal.

During the fifth period T5 when the first block 1441 emits light, control signals are provided to the first control line CL12, the second control line CL22, and the third control line CL32 at the second block 1442. Thus, the pixels 142 at the second block 1442 generate light of a predetermined luminance while repeating the above-mentioned process. Similarly, the pixels 142 in the third block to i-th block 144i are driven by the above-mentioned process.

In one embodiment, it is possible to additionally assign a predetermined period between the second period T2 and the third period T3 based on the rising and falling timing of the waveform. Further, for the purpose of the stable driving, the first control signal may be additionally provided during a predetermined period after the provision of the scan signal has been stopped.

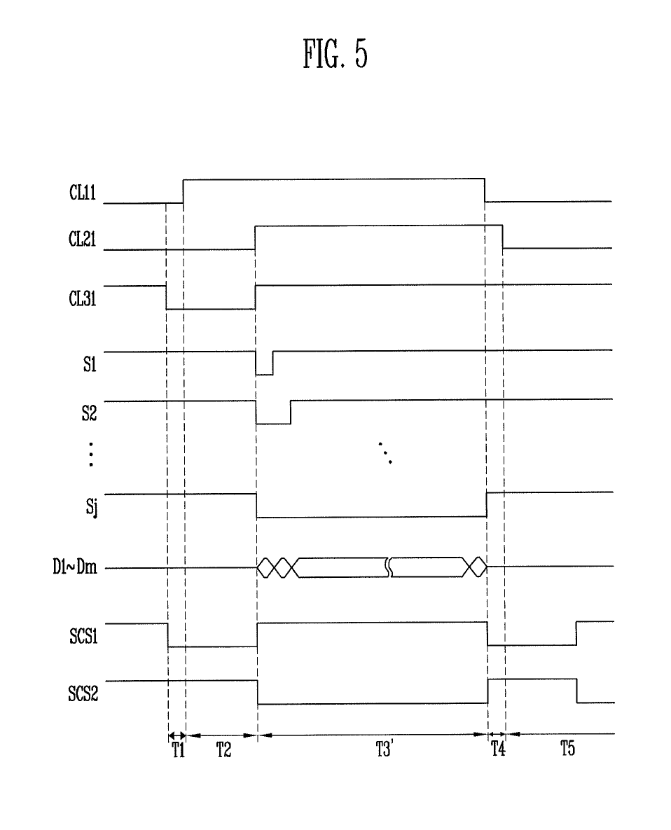

FIG. 5 illustrates another embodiment of a method for driving a display device. Referring to FIG. 5, in the third period T3′, the scan signal is simultaneously provided to the scan lines S1 to Sj and provision of the scan signal is sequentially stopped. For example, during the third period T3, the scan signal is simultaneously provided to the first scan line S1 to the j-th scan line Sj, and the provision of the scan signal is stopped in the order from the first scan line S1 to the j-th scan line Sj.

When the scan signal is simultaneously provided to the first scan line S1 to the j-th scan line Sj, the second transistor M2 of each pixel 142 in the first block 1441 is turned on. In this case, the data driver 130 provides the data signal corresponding to the first horizontal line to the data lines D1 to Dm.

The data signal provided to the data lines D1 to Dm is provided to the first node N1 of each of the pixels 142 in the first horizontal line to the j-th horizontal line. When the data signal is provided to the first node N1, the voltage of the first node N1 is changed from the voltage of the initial power source to the voltage of the data signal. The voltage of the second node N2 may also change depending on the capacitance ratio of the first capacitor C1 and the second capacitor C2. Then, the first capacitor C1 of each of the pixels 142 in the first block 1441 is provided with a data signal corresponding to the first horizontal line, and is charged with a voltage corresponding to the threshold voltage of the first transistor M1.

After the data signal corresponding to the first horizontal line has been provided, provision of the scan signal to the first scan line S1 is stopped. When provision of the scan signal to the first scan line S1 is stopped, each of the pixels 142 in the first horizontal line maintains the voltage stored in the first capacitor C1.

Subsequently, the data driver 130 provides a data signal corresponding to a second horizontal line to the data lines D1 to Dm. Then, the voltage of the data signal corresponding to the second horizontal line is stored in the first capacitor C1 of each of the pixels 142 in the second horizontal line and the j-th horizontal line. After the data signal corresponding to the second horizontal line has been provided, provision of the scan signal to the second scan line S2 is stopped. When provision of the scan signal to the second scan line S2 is stopped, each of the pixels 142 in the second horizontal line maintains the voltage stored in the first capacitor C1. Likewise, the pixels 142 in a third horizontal line to j-th horizontal line store the voltage corresponding to a desired data signal while repeating the above-described process.

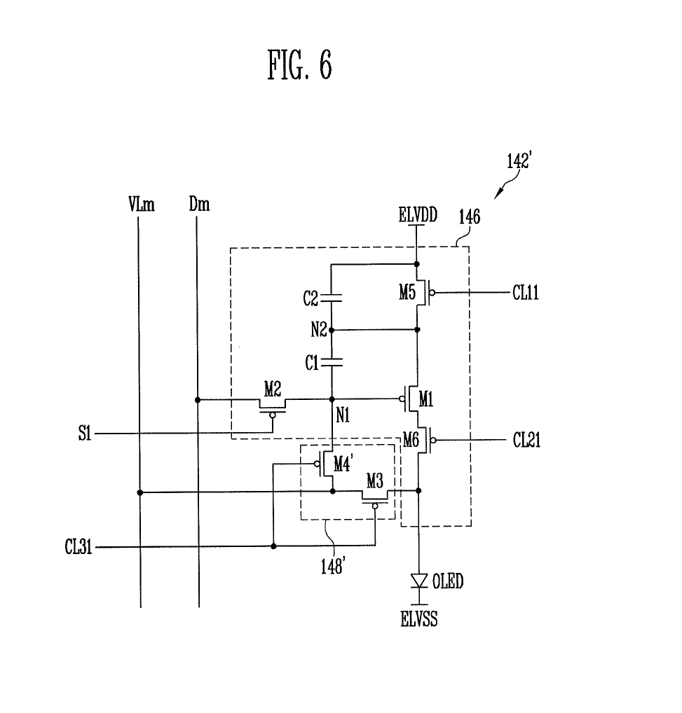

FIG. 6 illustrates a second embodiment of a pixel 142′ which includes a controller 148′ having a third transistor M3 (connected between the power line VLm and the anode electrode of the OLED) and a fourth transistor M4′ (connected between the power line VLm and the first node N1).

The third transistor M3 and the fourth transistor M4′ are turned on when the third control signal is provided from the third control line CL31, to thereby electrically connect the power line VLm, the anode electrode of the OLED, and the first node N1. The pixel of this embodiment may be similar to the pixel of the previous embodiment, except for the position of the fourth transistor M4′.

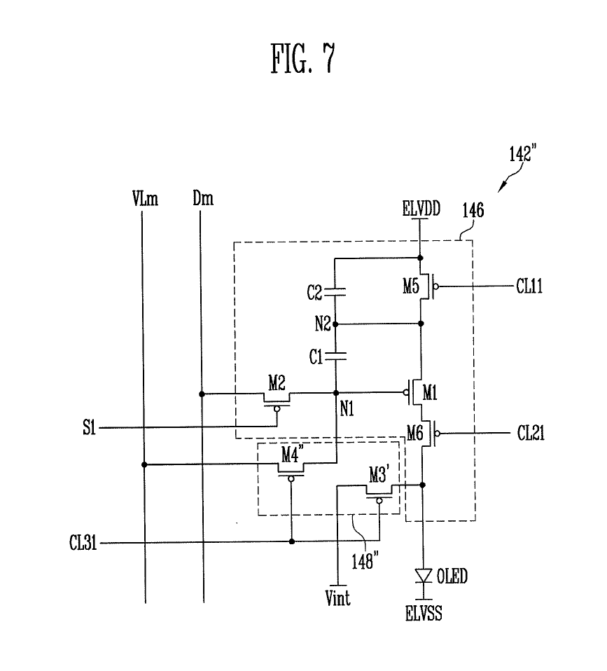

FIG. 7 illustrates third embodiment of a pixel 142″ which includes a controller 148″ having a fourth transistor M4″ and a third transistor M3′. The fourth transistor M4″ is connected between the power line VLm and the first node N1, and is turned on when the third control signal is provided to the third control line CL31. The third transistor M3′ that is connected between the initial power source Vint and the OLED, and is turned on when the third control signal is provided to the third control line CL31. The initial power source Vint is set to a voltage at which the OLED is turned off. Further, during the first period T1 and the second period T2, the voltage of the initial power source Vint or a specific voltage, which is within the voltage range of the data signal, is supplied to the power line VLm.

When the pixel of the first embodiment in FIG. 2 is provided with the third control signal, the first node N1 and the anode electrode of the OLED are connected to the power line VLm. Then, the voltage of the initial power source supplied to the power line VLm is supplied to the first node N1 and the anode electrode of the OLED. In this case, the voltage of the initial power source is limited to a voltage at which the OLED may be turned off Thus, the voltage supplied to the first node N1 may not be separately set, but is determined by the voltage of the initial power source.

In contrast, when the pixel of the third embodiment is provided with the third control signal, the first node N1 is connected to the power line VLm and the anode electrode of the OLED is connected to the initial power source Vint. The voltage supplied to the power line VLm may be set to the voltage of the initial power source or a specific voltage, for example, which is within the voltage range of the data signal.

For example, in the third embodiment, it is possible to freely set the voltage supplied to the first node N1 regardless of the voltage of the initial power source, thereby ensuring the freedom of design. The pixel of the third embodiment may be equal to that of the first embodiment, except for the controller 148″.

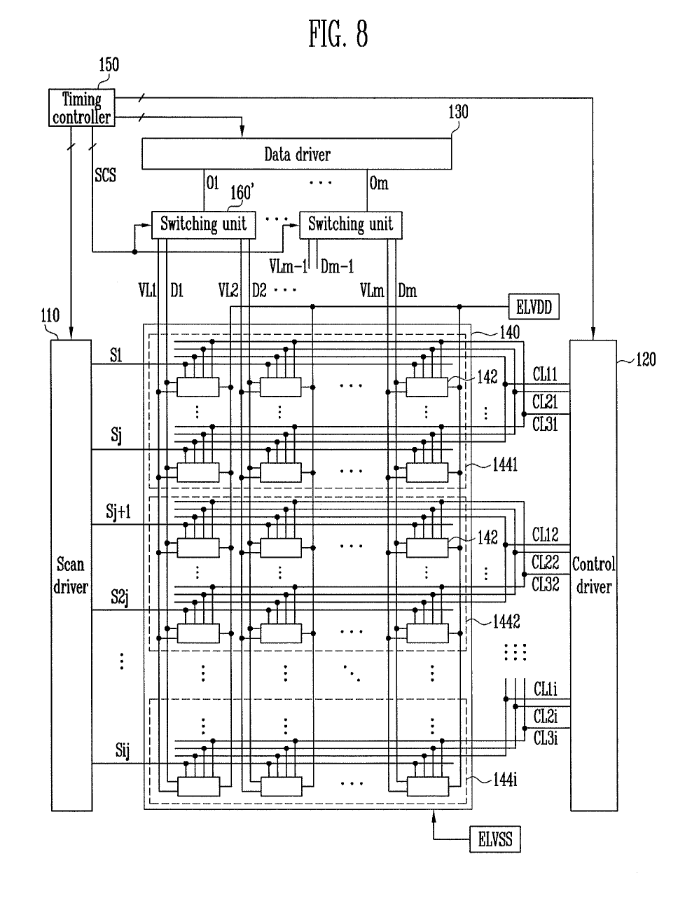

FIG. 8 illustrates a second embodiment of an organic light emitting display device which includes switching units 160′ connected to respective ones of the output lines O1 to Om. Further, the respective switching units 160′ are connected to a plurality of power lines and a plurality of data lines. The switching units 160′ serve as a demultiplexer that provides 1 data signals to the output lines during a first horizontal period to 1 data lines.

The respective switching units 160′ provide the data signal while sequentially connecting the 1 data lines connected to the switching units to the output lines during the first horizontal period when one scan signal is provided. The data driver 130 sequentially provides the 1 data lines to the respective output lines during the first horizontal period when the scan signal is provided. In addition, the switching unit 160 connects the output lines O1 to Om to the power lines VL1 to VLm during the period when the third control signal is provided.

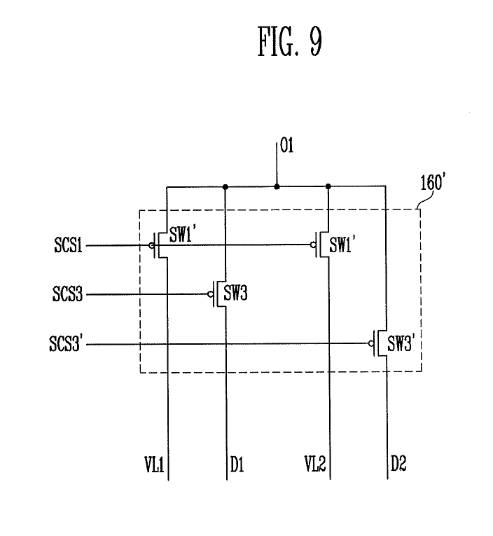

FIG. 9 illustrates another embodiment of a switching unit, which, for example, may be included in the display device of FIG. 8. For the convenience of description, FIG. 9 shows the switching unit 160′ connected to the first output line O1.

Referring to FIG. 9, the switching unit 160′ selectively connects the output line O1 to the power lines VL1 and VL2, the first data line D1, and the second data line D2 in response to the switching control signals SCS1, SCS3 and SCS3′. The switching unit 160′ includes first switches SW1′ and third switches SW3 and SW3′.

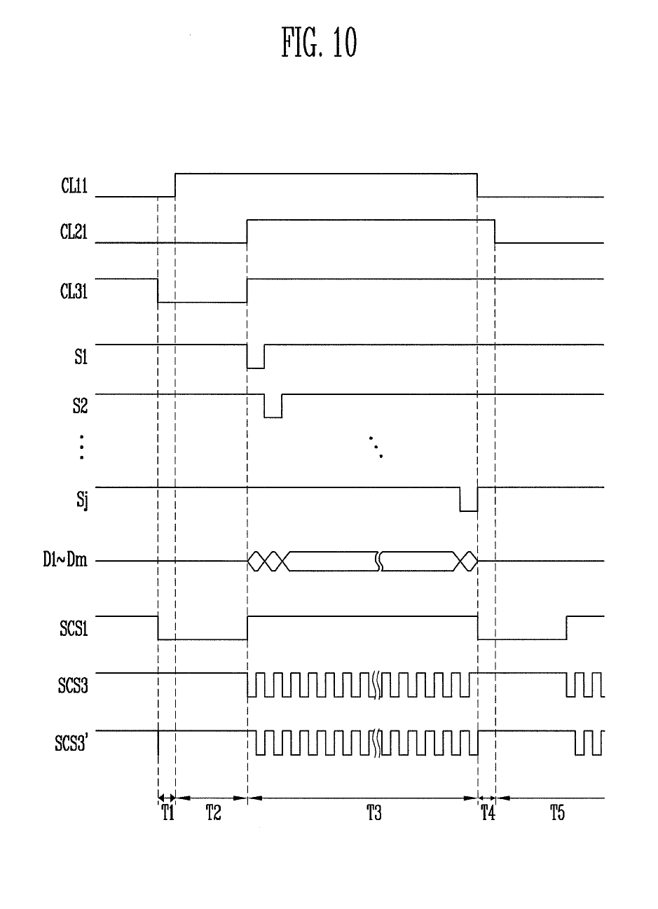

The first switches SW1′ are between the output line O1 and respective ones of the power lines VL1 and VL2, and are turned on by the first switching control signal SCS1. As shown in FIG. 10, the first switching control signal SCS1 is provided during a period when the third control signal is provided, so that the output line O1 is electrically connected to the power lines VL1 and VL2 during the period when the third control signal is provided. When the first switch SW1′ is turned on, the voltage of the initial power source supplied from the data driver 130 is supplied to the power lines VL1 and VL2.

The third switches SW3 and SW3′ are between the output line O1 and the respective data lines D1 and D2, and are turned on or off in response to the third switching control signals SCS3 and SCS3′. For example, the primary third switch SW3 connected to the first data line D1 is turned on when the primary third switching control signal SCS3 is provided, and the secondary third switch SW3′ connected to the second data line D2 is turned on when the secondary third switching control signal SCS3′ is provided.

The third switching control signals SCS3 and SCS3′ are alternately provided during the first horizontal period when the scan signal is provided. In this case, the third switches SW3 and SW3′ are sequentially turned on during the first horizontal period in response to the third switching control signals SCS3 and SCS3′. When the third switches SW3 and SW3′ are sequentially turned on, the output line O1 is sequentially connected to the data lines D1 and D2 in a first horizontal period. Then, two data signals, provided from the data driver 130 to the output line O1, are separately provided to the first data line D1 and the second data line D2.

The second embodiment of the switching unit 160′ may be similar to the switching unit 160 of the first embodiment, except that the switching unit 160′ additionally serves as a demultiplexer.

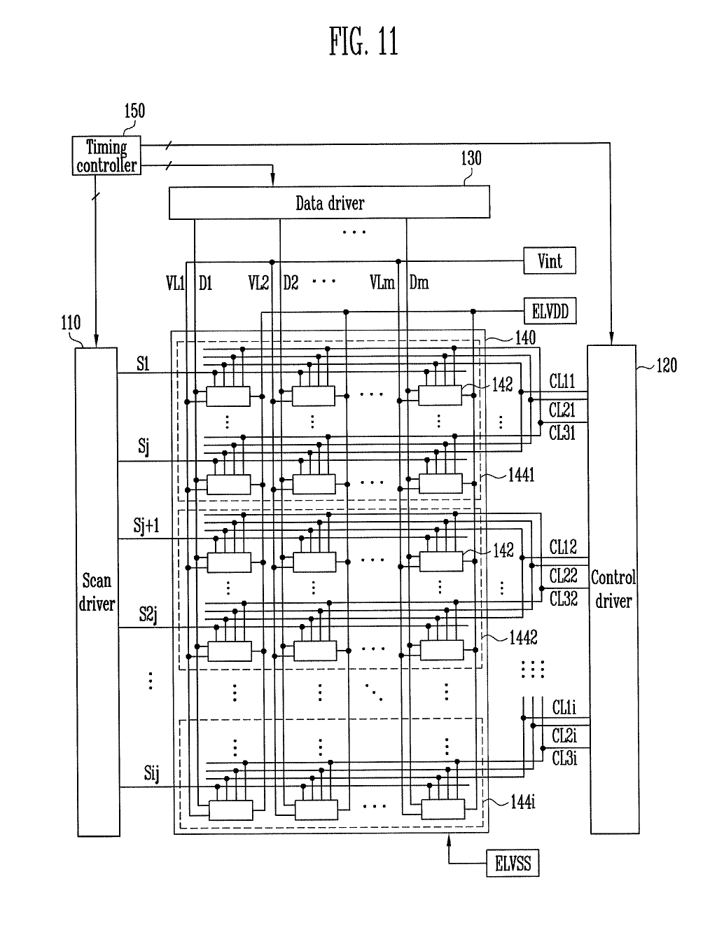

FIG. 11 illustrates a third embodiment of an organic light emitting display device in which the power lines VL1 to VLm are electrically connected to the external initial power source Vint. In this case, the power lines VL1 to VLm always maintain the voltage of the initial power source Vint. The voltage of the initial power source Vint supplied to the power lines VL1 to VLm is supplied to the pixels 142 on a block basis in response to the third control signal sequentially provided to the third control lines CL31 to CL3i. The remaining driving process may be equal to that of the display device of the first embodiment.

The transistors illustrated in the drawings are PMOS transistors. In other embodiments, the transistors may be NMOS transistors, or a combination of NMOS and PMOS transistors may be used. Further, the OLED of each pixel may emit a predetermined color of light, e.g., red, green, blue, or white light, in proportion to the supplied current. When the OLED generates white light, it is possible to implement a color image using a separate color filter.

By way of summation and review, one type of organic light emitting display device includes a plurality of pixels arranged in matrix. The pixels are located at intersections of data lines, scan lines, and power lines. The pixels include an OLED, two or more transistors including a driving transistor, and one or more capacitors.

Such a display device is low in power consumption, but is disadvantageous in that a current flowing in the OLED is changed according to the threshold-voltage deviation of the driving transistor included in each of the pixels, thereby causing a non-uniform display. For example, according to the manufacturing-process parameter of the driving transistor in each of the pixels, the characteristics of the driving transistor are changed. Thus, it is difficult to manufacture an organic light emitting display device in which all transistors have the same characteristics. This results in threshold-voltage deviation of the driving transistors.

In an effort to overcome this problem, one approach involves adding a compensation circuit having a plurality of transistors and capacitors to each of the pixels. The compensation circuit in each of the pixels charges a voltage corresponding to the threshold voltage of the driving transistor during the first horizontal period, to thereby compensate for deviation of the driving transistor.

In order to implement a motion blur phenomenon and/or a 3D image, a driving method using the driving frequency of 120 Hz or more is generally required. However, the high-speed driving of 120 Hz or more is problematic, in that a time for charging the threshold voltage of the driving transistor is reduced. This makes it difficult to compensate for the threshold voltage of the driving transistor.

In accordance with one or more of the aforementioned embodiments, a pixel and an organic light emitting display device using the pixel allows the threshold voltage of the driving transistor in each pixel to be compensated for on a block basis. As a result, a sufficient time is assigned to perform threshold-voltage compensation.

Further, in at least one embodiment, only the voltage of the data signal is supplied to the data lines, to thereby prevent the voltage of the data lines from being rapidly changed. This may prevent defective driving from occurring, for example, due to a load resulting from a voltage difference.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A pixel, comprising:
an organic light emitting diode (OLED); and
a pixel circuit including:
a first transistor to control current from a first power source to the OLED based on a voltage applied to a first node; and
a second transistor connected between the first node and a data line, the second transistor to turn on based on a scan signal applied to a scan line; and
a controller to supply a voltage from a power line to at least one of the first node or an anode electrode of the OLED.

2. The pixel as claimed in claim 1, wherein:
the controller includes a third transistor and a fourth transistor connected in series between the anode electrode of the OLED and the power line, and
a common node of the third transistor and the fourth transistor is connected to the first node.

3. The pixel as claimed in claim 1, wherein:
the controller includes a third transistor connected between the anode electrode of the OLED and the power line; and
a fourth transistor connected between the first node and the power line.

4. The pixel as claimed in claim 1, wherein:
the controller includes a third transistor connected between the anode electrode of the OLED and a initial power source; and
a fourth transistor connected between the first node and the power line.

5. The pixel as claimed in claim 1, wherein the pixel circuit includes:
a first capacitor and a second capacitor connected in series between the first node and the first power source;
a fifth transistor connected between a first electrode of the first transistor and the first power source; and
a sixth transistor connected between a second electrode of the first transistor and the anode electrode of the OLED, wherein a common node of the first capacitor and the second capacitor is connected to the first electrode of the first transistor.

6. An organic light emitting display device, comprising:
pixels in a region including scan lines, data lines, and power lines, the pixels to be supplied with a predetermined voltage from the power lines;
i blocks divided to include two or more scan lines, where i≧2;
a control driver to provide a first control signal to i first control lines, a second control signal to i second control lines, and a third control signal to i third control lines;
a scan driver to provide a scan signal to the scan lines; and
a data driver including a plurality of output lines, the data driver to provide a data signal to the data lines connected to the output lines, wherein the power lines are to be supplied with an initial voltage from the output lines or an initial power source.

7. The device as claimed in claim 6, further comprising:
a plurality of switching circuits connected to respective ones of the output lines, each of the switching circuits connected to one of the power lines and one of the data lines.

8. The device as claimed in claim 7, wherein one of the switching circuits connected to a k-th output line includes:
a first switch connected between the k-th output line and a k-th power line, the first switch to turn on based on a first switching control signal; and
a second switch connected between the k-th output line and a k-th data line, the second switch to turn on based on a second switching control signal.

9. The device as claimed in claim 8, wherein:
the first switching control signal is provided before the scan signal is provided to the scan lines in a corresponding one of the blocks, and
the second switching control signal is provided during a period when the scan signal is provided to the scan lines in the corresponding one of the blocks.

10. The device as claimed in claim 8, wherein the data driver is to:
supply a first voltage of the initial power source to the k-th output line during a period when the first switching control signal is provided, the first voltage to block supply of data to the output line, and
provide the data signal to the k-th output line during a period when the second switching control signal is provided.

11. The device as claimed in claim 6, further comprising:
a plurality of switching circuits connected to respective ones of the output lines, multiple ones of the power lines, and multiple ones of the data lines.

12. The device as claimed in claim 11, wherein each switching circuit includes:
a first switch connected between a corresponding one of the output lines and the multiple ones of the power lines, the first switch to turn on based on a first switching control signal; and
second switches connected between the corresponding one of the output lines and the multiple ones of the data lines, the second switches to turn on in response to a plurality of second switching control signals.

13. The device as claimed in claim 12, wherein:
the first switching control signal is provided before the scan signal is provided to the scan lines in a corresponding one of the blocks, and
the second switching control signals are sequentially provided during a first horizontal period when the scan signal is provided to the scan lines in the corresponding one of the blocks.

14. The device as claimed in claim 12, wherein the data driver is to:
supply a voltage of the initial power source, at which OLEDs in the pixels are turned off, to the output lines during a period when the first switching control signal is provided, and
sequentially provide data signals to the output lines during a period when the second switching control signals are provided.

15. The device as claimed in claim 6, wherein the control driver is to:
provide the second control signal to a j-th second control line after providing the first control signal to a j-th first control line, and stop providing the second control signal after the first control signal is stopped being provided, and
provide the third control signal to a j-th third control line before providing the first control signal to the j-th first control line, and stop providing the third control signal before the scan signal is provided to scan lines in a j-th block.

16. The device as claimed in claim 15, wherein the scan driver is to sequentially provide the scan signal to the scan lines in the j-th block when the first control signal provided to the j-th first control line overlaps the second control signal provided to the j-th second control line.

17. The device as claimed in claim 15, wherein:
the first control signal and the second control signal are to be set to a voltage at which pixel transistors are turned off, and
the third control signal and the scan signal are to be set to a voltage at which the pixel transistors are turned on.

18. The device as claimed in claim 15, wherein the scan driver is to:
simultaneously provide the scan signal to the scan lines in the j-th block, and
sequentially stop providing the scan signal when the first control signal provided to the j-th first control line overlaps the second control signal provided to the j-th second control line.

19. The device as claimed in claim 15, wherein each of the pixels in the j-th block includes:
an OLED;
a pixel circuit including:
a first transistor to control a current supplied from a first power source to the OLED depending on a voltage applied to a first node;
a second transistor connected between the first node and a data line, the second transistor to turn on when a scan signal is provided to a scan line;
a first capacitor and a second capacitor connected in series between a first electrode of the first transistor and the first power source, a common node of the first and second capacitors connected to the first electrode of the first transistor;
a fifth transistor connected between the first electrode of the first transistor and the first power source, the fifth transistor to turn off when the first control signal is provided to a j-th first control line;
a sixth transistor connected between a second electrode of the first transistor and an anode electrode of the OLED, the sixth transistor to turn off when the second control signal is provided to a j-th second control line; and
a controller to connect a power line to at least one of the first node or the anode electrode of the OLED when a third control signal is provided to a j-th third control line.

20. The device as claimed in claim 19, wherein the controller includes:
a third transistor and a fourth transistor connected in series between the anode electrode of the OLED and the power line, wherein the third and fourth transistors are to turn on when the third control signal is provided to the j-th third control line, and wherein a common node of the third and fourth transistors are connected to the first node.
